(19) United States
(12) Patent Application Publication
(10) Pub. No.: US 2021/0027620 A1
(43) Pub. Date: Jan. 28, 2021

(54) METHODS AND SYSTEMS FOR DETERMINING SPEED OF A VEHICLE

(71) Applicant: HERE GLOBAL B.V., Eindhoven (NL)

(72) Inventor: Evgeny LUK-ZILBERMAN, Herzliya (IL)

(21) Appl. No.: 16/523,660

(22) Filed: Jul. 26, 2019

(51) Int. Cl. G08G 1/054; G06T 7/20; G06N 3/08

(52) U.S. Cl. CPC G08G 1/054; G06N 3/08; G06T 7/20

(57) ABSTRACT

A system, a method, and a computer program product may be provided for determining speed data of a vehicle. A system may include a memory configured to store computer program code instructions; and a processor configured to execute the computer program code instructions to obtain live video data associated with the vehicle and determine the speed data of the vehicle from the live video data using a three dimensional (3D) convolution neural network (CNN) model. The live video data may include one or more video clips. The 3D-CNN model may include a plurality of convolution layers, a plurality of pooling layers, and a plurality of fully connected layers. The processor is further configured to generate a speed violation notification based on the determined speed data of the vehicle and control an output interface of one or more user devices to render the generated speed violation notification.

### TECHNOLOGICAL FIELD

The present disclosure generally relates to determining speed of a vehicle, and more particularly relates to determining the speed of the vehicle from live video data using a machine learning model.

### BACKGROUND

Commonly, navigation uses global positioning system/network (GPS) signals to determine location and speed. The data from the GPS signals associated with the vehicle can be collected over time to determine a navigation path taken by the vehicle. However, the GPS signals are mostly reliable on the earth's terrain, and hence may not be available in certain locations, such as inside buildings or tunnels.

Speed of a vehicle is commonly determined using the GPS signals. The problem of unavailability of GPS signals in certain locations is usually addressed by using an inertial measurement unit (IMU), such as, an accelerometer and a gyroscope to determine distance, using which speed of the vehicle is determined. Such solutions require an integration of samples of sensor data from different sensors and thus, such solutions suffer from synchronization problems between the sensors.

Accordingly, there is a need to determine the speed data of the vehicle under circumstances where GPS coordinates may be unavailable and unreliable without a need to use samples of sensor data from additional sensors.

### BRIEF SUMMARY

A system, a method, and a computer program product are provided in accordance with an example embodiment described herein for determining speed data of a vehicle. Embodiments disclosed herein may provide a system for determining speed data of a vehicle. The system may include at least one non-transitory memory configured to store computer program code instructions, and at least one processor configured to execute the computer program code instructions to at least: obtain live video data associated with the vehicle and determine the speed data of the vehicle from the live video data using a three dimensional (3D) convolution neural network (CNN) model. The live video data comprises one or more video clips, each having equal frame count. The 3D-CNN model comprises a plurality of convolution layers, a plurality of pooling layers, and a plurality of fully connected layers.

The at least one processor is further configured to generate a speed violation notification based on the determined speed data of the vehicle and control an output interface of one or more user devices associated with the vehicle to render the generated speed violation notification. The at least one processor is further configured to preprocess the live video data associated with the vehicle into the one or more video clips comprising a plurality of image frames. the at least one processor is further configured to extract spatio-temporal features of the live-video data using the plurality of convolution layers and the plurality of pooling layers of the 3D-CNN model.

The 3D-CNN model comprises a first set of layers including two convolution layers of the plurality of convolution layers and two pooling layers of the plurality of pooling layers stacked in an alternating sequence. The 3D-CNN model further comprises a second set of layers connected to the first set of layers including a third convolution layer and a fourth convolution layer of the plurality of convolution layers connected to the first set of layers in succession, a third pooling layer connected to the fourth convolution layer, a fifth convolution layer connected to the third pooling layer, a fourth pooling layer connected to the fifth convolution layer in a sequence. The 3D-CNN model further comprises a fully connected layer connected to the second set of layers and a softmax layer connected to the fully connected layer.

In an example embodiment, a method for determining speed data of a vehicle may be provided that includes: obtaining live video data associated with the vehicle and determining the speed data of the vehicle from the live video data using a three dimensional (3D) convolution neural network (CNN) model. The method may further include generating a speed violation notification based on the determined speed data of the vehicle and controlling an output interface of one or more user devices associated with the vehicle to render the generated speed violation notification. The method further comprises preprocessing the live video data associated with the vehicle into one or more video clips comprising a plurality of image frames and extracting spatio-temporal features of the live-video data using the plurality of convolution layers and the plurality of pooling layers.

Embodiments of the present invention may provide a computer program product including at least one non-transitory computer-readable storage medium having computer-executable program code instructions stored therein. The computer-executable program code instructions when executed by a computer, cause the computer to carry out operations for determining speed data of a vehicle, the operations including: obtaining live video data associated with the vehicle and determining the speed data of the vehicle from the live video data using a three dimensional (3D) convolution neural network (CNN) model. According to some embodiments, the operations further include: generating a speed violation notification based on the determined speed data of the vehicle and controlling an output interface of one or more user devices associated with the vehicle to render the generated speed violation notification. The operations may further comprise preprocessing the live video data associated with the vehicle into one or more video clips comprising a plurality of image frames and extracting spatio-temporal features of the live-video data using the plurality of convolution layers and the plurality of pooling layers.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of an environment of operation of a system for determining speed data of a vehicle from live video data, in accordance with an example embodiment;

FIG. 2 exemplarily illustrates a block diagram of the system that may be used to determine speed data of the vehicle from live video data, in accordance with an example embodiment;

FIG. 3 exemplarily illustrates a flowchart showing architecture of a validated 3D-CNN model, in accordance with an exemplarily embodiment, in accordance with an example embodiment;

FIG. 4 exemplarily illustrates a flowchart comprising the steps performed by the system for training and validating the 3D-CNN model for determining the speed data of the vehicle from live video data, in accordance with an example embodiment;

FIGS. 5A-5L exemplarily illustrate a video clip of image frames constituting the training video data sets for training the 3D-CNN model, in accordance with an embodiment;

FIGS. 6A-6L exemplarily illustrate a video clip of image frames constituting the training video data sets for training the 3D-CNN model, in accordance with an embodiment;

FIG. 7 exemplarily illustrates a schematic diagram representing generation of a speed violation notification by the system, in accordance with an embodiment; and

FIG. 8 exemplarily illustrates a method for determining speed data of a vehicle, in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

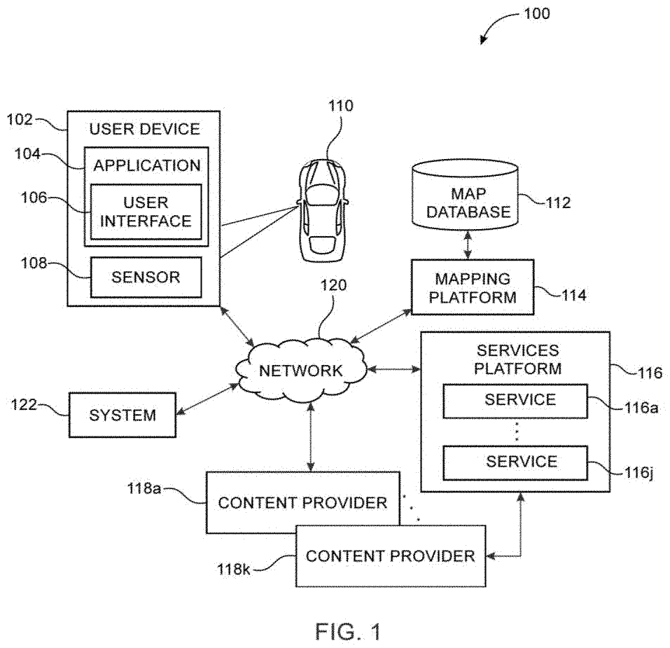

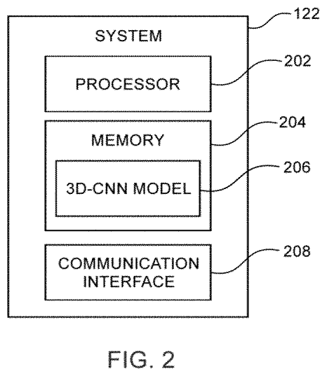

FIG. 1 illustrates a schematic diagram of an environment 100 of operation of a system 122 for determining speed data of a vehicle 110 from live video data, in accordance with an example embodiment. The system 122 obtains live video data captured from one or more sensors 108, such as, imaging sensors, for example, video cameras, dash board cameras, web cameras, camcorders, etc., associated with the vehicle 110. The vehicle 110 may be an autonomous vehicle. In some example embodiments, the vehicle 110 may be non-autonomous manually driven vehicle. The autonomous vehicle may refer to a vehicle having autonomous driving capabilities at least in some conditions. The autonomous vehicle may have fully autonomous or semi-autonomous driving capabilities at least in some conditions with minimal or no human interference. For example, an autonomous vehicle is a vehicle that drives and/or operates itself without a human operator but may or may not have one or more passengers. The system 122 may employ a machine learning model as disclosed in the detailed description of FIG. 2 to determine speed data of the vehicle 110 from the live video data.

As exemplarily illustrated, the environment 100 includes a user equipment (UE) or a user device 102, which may be in communication with the system 122 over a network 120. The network 120 may be wired, wireless, or any combination of wired and wireless communication networks, such as cellular, Wi-Fi, internet, local area networks, or the like. In one embodiment, the network 120 may include one or more networks, such as, a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The user device 102 may be a navigation system, that may be configured to provide route guidance and navigation related functions to the user of the vehicle 110. The user device 102 may be installed in the vehicle 110 or may be in possession of the occupants of the vehicle 110. The user device 102 may also include an image capturing device, such as a camera that may function as a dashboard camera or a web based camera. The user device 102 may also include one or more sensors 108 such as an acceleration sensor, a gyroscopic sensor, a LIDAR sensor, a proximity sensor, a motion sensor and the like. The sensors 108 may primarily be used for determining positioning of the vehicle 110 and the sensors 108 may be built-in or embedded into or within interior of the user device 102.

The user device 102 may include a mobile computing device such as a laptop computer, tablet computer, mobile phone, smart phone, navigation unit, personal data assistant, watch, camera, or the like. Additionally or alternatively, the user device 102 may be a fixed computing device, such as a personal computer, computer workstation, kiosk, office terminal computer or system, or the like. The user device 102 may be configured to access a mapping platform 106 through, for example, a user interface 106 of a mapping application 104, such that the user device 102 may provide navigational assistance to the user among other services provided through access to the mapping platform 114. In some embodiments, the user device 102 uses communication signals for position determination. The user device 102 may receive location data from a positioning system, a Global Navigation Satellite System, such as Global Positioning System (GPS), Galileo, GLONASS, BeiDou, etc., cellular tower location methods, access point communication fingerprinting such as Wi-Fi or Bluetooth based radio maps, or the like. The data collected by the sensors 108 may be used to gather information related to an environment of the vehicle 110. Vehicle data, also referred to herein as “probe data”, may be collected by any device capable of determining the necessary information, and providing the necessary information to a remote entity. The user device 102 is one example of a device that can function as a probe to collect probe data of a vehicle 110.

More specifically, probe data collected by the user device 102 may be representative of the location of a vehicle 110 at a respective point in time and may be collected while the vehicle 110 is traveling along a route. While probe data is described herein as being vehicle probe data, example embodiments may be implemented with pedestrian probe data, marine vehicle probe data, or non-motorized vehicle probe data (e.g., from bicycles, skate boards, horseback, etc.). According to the example embodiment described below with the probe data being from motorized vehicles traveling along roadways, the probe data may include, without limitation, location data, (e.g. a latitudinal, longitudinal position, and/or height, GNSS coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The user device 102, may be any device capable of collecting the aforementioned probe data.

As exemplarily illustrated, the mapping platform 114 may communicate with a map database 112, which may include node data, road segment data or link data, point of interest (POI) data, posted signs related data or the like. The map database 112 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, for example, cars, trucks, buses, motorcycles, and/or other entities. Optionally, the map database 112 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 112 can include data about the POIs and their respective locations in the POI records. The map database 108 may additionally include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 112 can include event data (e.g., traffic incidents, construction activities, scheduled events, unscheduled events, etc.) associated with the POI data records or other records of the map database 112 associated with the mapping platform 114. The map database 112 may additionally include, data about traffic regulations, speed limits, posted traffic signs, posted speed limit signs, heading data, and the like.

A content provider such as a map developer may maintain the mapping platform 114. By way of example, the map developer can collect geographic data to generate and enhance the mapping platform 114. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Crowdsourcing of geographic map data can also be employed to generate, substantiate, or update map data. For example, sensor data from a plurality of data probes, which may be, for example, vehicles traveling along a road network or within a venue, may be gathered and fused to infer an accurate map of an environment in which the data probes are moving. Such sensor data may be updated in real time such as on an hourly basis, to provide accurate and up to date map data. Also, remote sensing, such as aerial or satellite photography, can be used to generate map geometries directly.

The map database 112 of the mapping platform 114 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as, by the user device 102, for example. The navigation-related functions can correspond to vehicle navigation, pedestrian navigation, navigation to a favored parking spot or other types of navigation. While example embodiments described herein generally relate to vehicular travel and parking along roads, example embodiments may be implemented for bicycle travel along bike paths and bike rack/parking availability, boat travel along maritime navigational routes including dock or boat slip availability, off-street parking predictions, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

In some embodiments, the mapping platform 114 may be a master geographic database configured at a server side, but in alternate embodiments, a client side mapping platform 114 may represent a compiled navigation database that may be used in or with end user devices (e.g., user device 102) to provide navigation, speed adjustment and/or map-related functions. For example, the mapping platform 114 may be used with the end user device, that is, the user device 102 to provide the user with navigation features. In such a case, the mapping platform 114 can be downloaded or stored on the user device 102 which can access the mapping platform 114 through a wireless or a wired connection, over the network 120.

In one embodiment, the user device or the user equipment 102 can be an in-vehicle navigation system, such as, an infotainment system, a personal navigation device (PND), a portable navigation device, a cellular telephone, a smart phone, a personal digital assistant (PDA), a watch, a camera, a computer, a workstation, and/or other device that can perform navigation-related functions, such as digital routing and map display. An end user can use the user equipment 102 for navigation and map functions such as guidance and map display, for example, notification on exceeding speed limits on a route, according to some example embodiments. The user device 102 may include an application, for example, a mapping application 104 with a user interface 102 that may enable the user to access the system 122 and the mapping platform 114 for availing the functions, such as, determining speed data of the vehicle 110 from the captured live video data.

The environment 100 may further include a services platform 116, which may be used to provide navigation related functions and services 116a-116i to the application 104 running on the user device 102. The services 116a-116i may include such as navigation functions, speed adjustment functions, traffic related updates, weather related updates, warnings and alerts, parking related services, indoor mapping services, and the like. The services 116a-116i may be provided by a plurality of content providers 118a-118k. In some examples, the content providers 118a-118k may access various SDKs from the services platform 116 for implementing one or more services. In an example, the services platform 116 and the mapping platform 114 may be integrated into a single platform to provide a suite of mapping and navigation related applications for OEM devices, such as the user device 102. The user device 102 may be configured to interface with the services platform 116, the content provider's services 118a-118k, and the mapping platform 114 over a network 120. Thus, the mapping platform 114 and the services platform 116 in combination with the system 122 may enable provision of cloud-based services for the user device 102, such as, determining speed data of the vehicle 110 carrying the user device 102, from live video data.

FIG. 2 exemplarily illustrates a block diagram of the system 122 that may be used to determine speed data of the vehicle 110 from live video data, in accordance with an example embodiment of the present invention. In the embodiments described herein, the system 122 may include a processing means, such as, at least one processor (hereinafter interchangeably used with processor) 202, a storage means, such as, at least one memory (hereinafter interchangeably used with memory) 204, and a communication means, such as, at least one communication interface (hereinafter interchangeably used with communication interface) 208. The processor 202 may retrieve computer program code instructions that may be stored in the memory 204 for execution of the computer program code instructions. The memory 204 may store a three dimensional (3D) convolution neural network (CNN) (3D-CNN) model 206 that is trained and tested to determine the speed data of the vehicle 110 from live video data. The processor 202 receives from a user, input such as live video data, and renders output, such as, the determined speed data of the vehicle, speed violation notification, etc., for use by the user through the communication interface 208.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 122.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus to carry out various functions in accordance with an example embodiment of the present invention. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202. The environment, such as, 100 may be accessed using the communication interface 208 of the system 122. The communication interface 208 may provide an interface for accessing various features and data stored in the system 122.

The processor 202 of system 122 generates a validated 3D-CNN model 206 and stores in the memory 204. The 3D-CNN model 206 is a variant of a convolutional neural network model. The convolutional neural network model is a type of artificial neural network model used for processing pixel data in an image for image recognition and image processing. The CNN model is based on deep learning algorithm which takes an input image as pixel data, assigns importance to various aspects or objects in the input image to extract features of the input image that are important for discrimination and suppresses irrelevant variations, and outputs a correct label for the extracted features. The 3D-CNN model 206 takes a video as an input, extracts features from a set of images that constitute the video, and outputs a label for the video for which the 3D-CNN model 206 is trained.

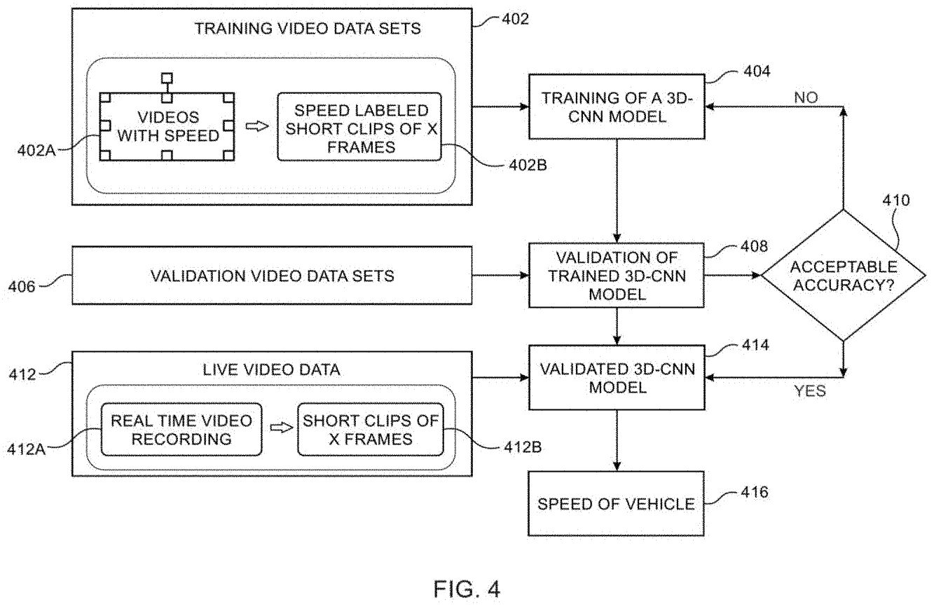

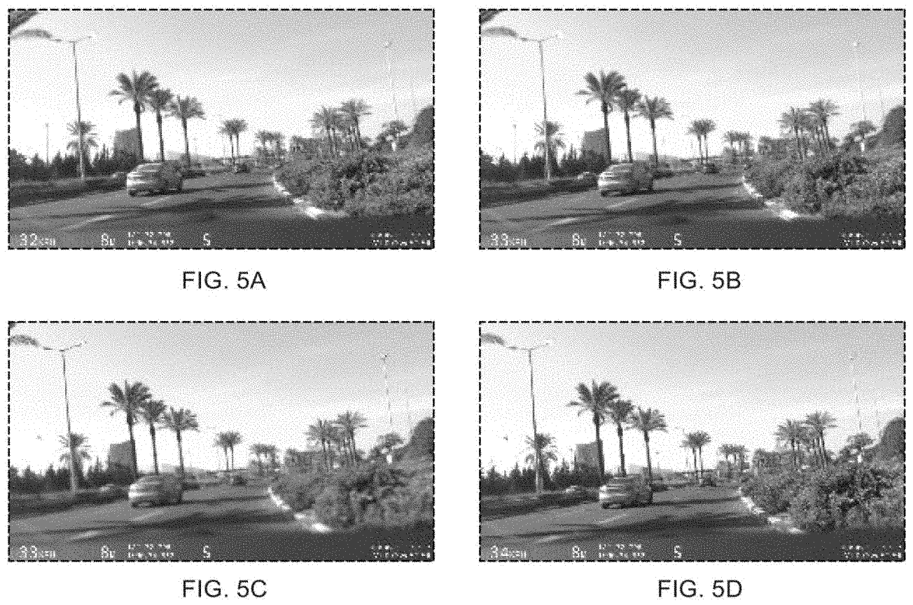

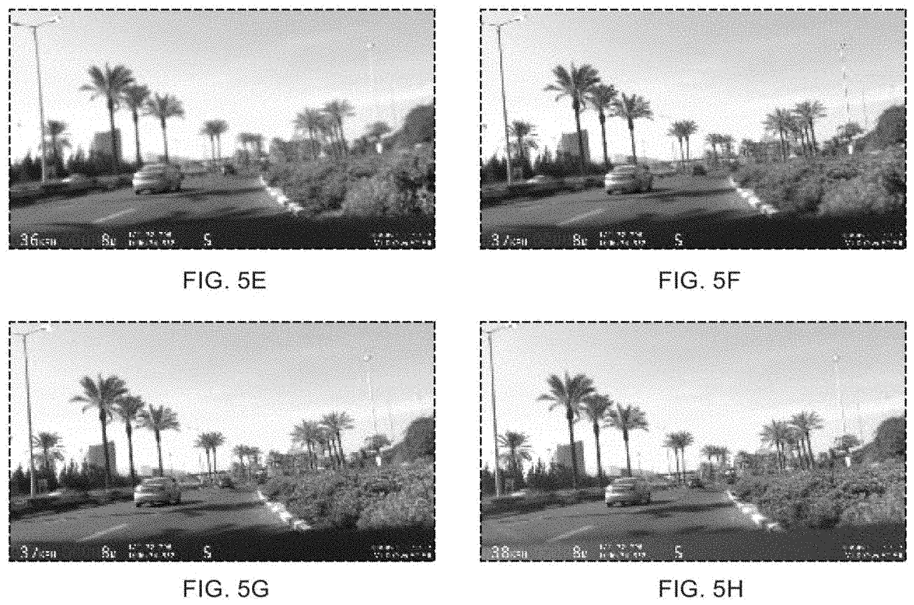

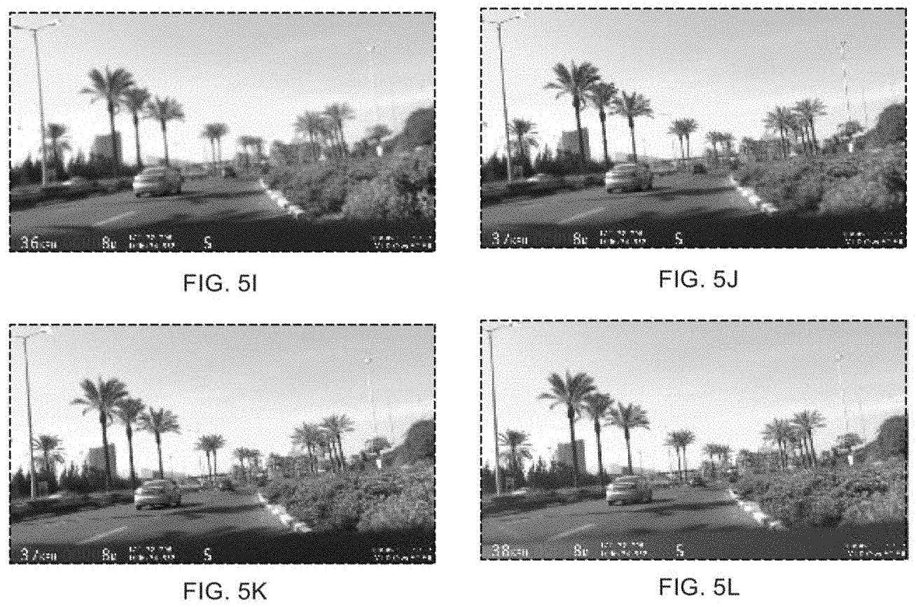

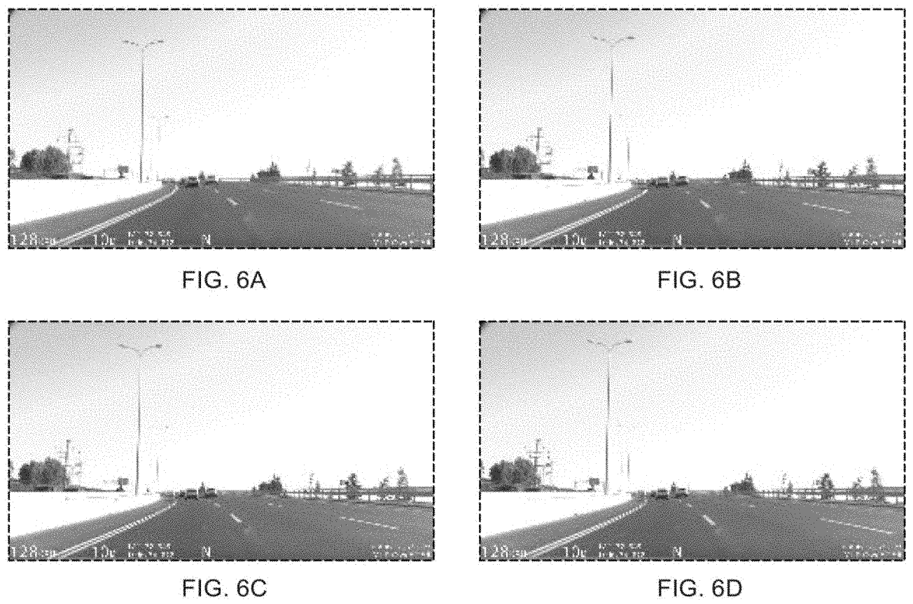

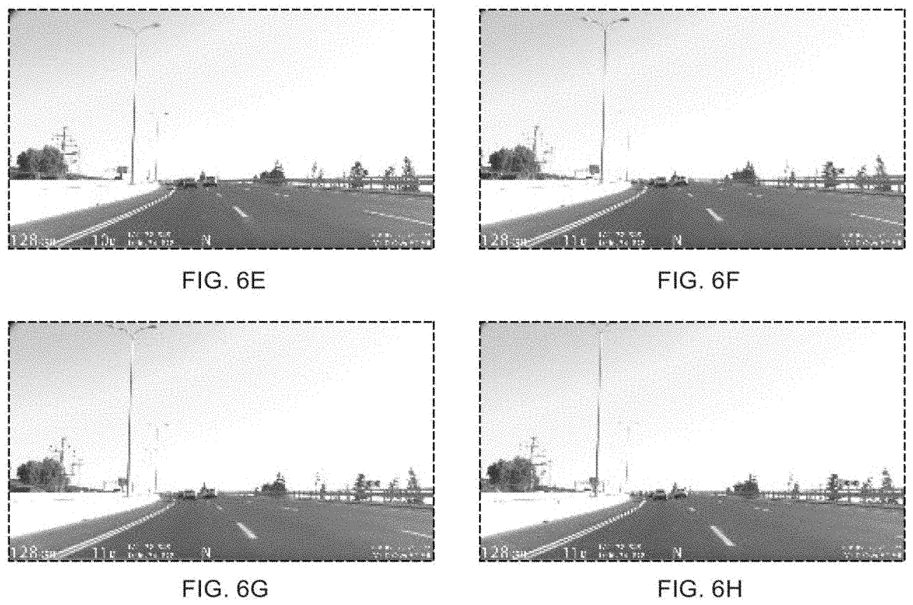

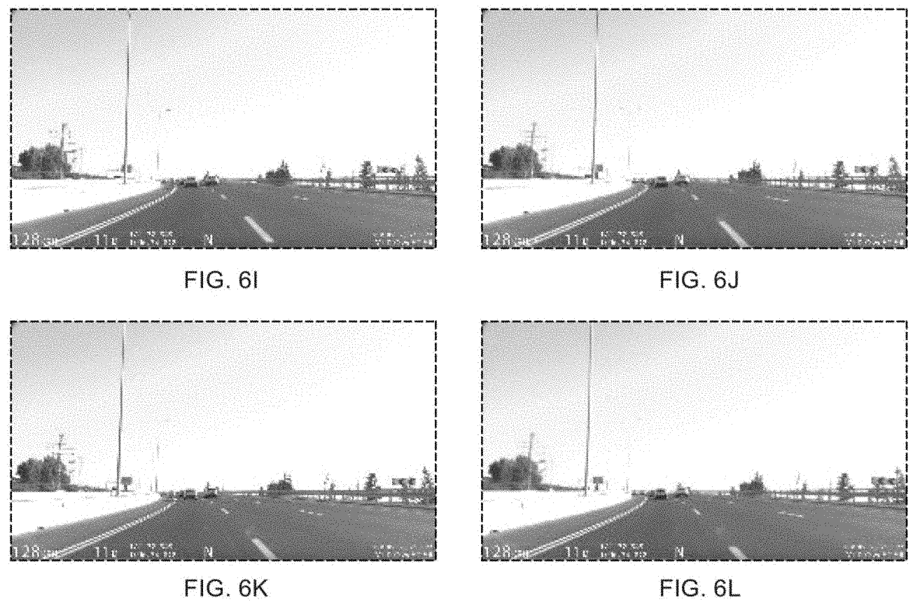

The processor 202 trains the 3D-CNN model 206 using a plurality of training video data sets as exemplarily illustrated in FIGS. 5A-5L and validates using a plurality of validation video data sets as exemplarily illustrated in FIGS. 6A-6L. Based on the accuracy of determining the speed data of the vehicle 110 from the validation video data sets, the processor 202 re-trains the 3D-CNN model 206 until a validated 3D-CNN model 206 is generated. To the validated 3D-CNN model 206, the processor 202 inputs live video data to obtain the speed data of the vehicle 110 from the live video data as will be described in the detailed description of FIG. 4.

The 3D-CNN model 206 comprises a plurality of layers for feature extraction and a plurality of layers for classification or labelling. The plurality of layers for feature extraction comprise one or more convolution layers and one or more pooling layers. The plurality of layers for classification are one or more fully connected layers. A convolution layer reduces the pixel data in the images into a form which is easier to process, without losing features that are critical for correct prediction. The convolution layer involves convoluting an input image with a kernel to obtain a feature map of the image. The kernel is a filter that is slid over the image and convoluted with the pixel data at the locations of the kernel to obtain a feature map. The kernel functions as feature detectors of the input image. Different kernels when convoluted with the input image may generate different feature maps. A collection of kernels is a filter.

The input to the 3D-CNN model is a multi-channel image, such as, a 3-channel RGB image. Each channel of the input image is convoluted with a kernel of a certain size. The number of kernels used for convoluting the multi-channel image may depend on the number of channels of the input image.

The different parameters of the filter that govern the size of the feature map are depth of the filter, stride of the kernel, and zero-padding of the kernel. The depth of the filter corresponds to the number of the kernels being used for convoluting the input image. The stride of the kernel refers to the number of steps by which the filter slides over the input image. In an embodiment, the stride of the kernel may be manually configured during the process of training the 3D-CNN model. The zero-padding of the kernel is padding the kernel with zeros to ensure when the input image is convoluted with the kernel, many of the features of the input image are retained till the next stage of convolution. The zero-padding of the kernel allows control of the size of the feature maps.

On convolution of the input image with the kernel, the processor 202 obtains a convoluted image that is a feature map of the image from the 3D-CNN model. The processor 202 uses an activation function, such as, a Relu, tanh, sigmoid, etc. on the feature map to introduce non-linearity. The non-linearity is introduced since in real-world the 3D-CNN model may have to train on non-linearities. The output of a Relu activation function is expressed as Max (0, Input) and the Relu activation function replaces all negative pixel data in the feature map by zero and the processor 202 obtains a rectified feature map as the output of the Relu function.

The processor 202 reduces the dimensionality of the obtained rectified feature map but retains important information of the rectified feature map. The processor 202 reduces the dimensionality of the rectified feature map using spatial pooling, such as, Max, Average, Sum, etc. Predominantly used is the Max pooling and the processor 202 extracts the largest pixel data in a window of the rectified feature map and replaces that window with the extracted largest pixel data to output a maxpooled feature map. On doing so, some of the inferior features of the rectified feature map are suppressed by the dominant features of the rectified feature map.

The obtained maxpooled feature map is an output of a first convolution layer succeeded by a first pooling layer in the 3D-CNN model. The first pooling layer may be succeeded by one or more convolution layers and one or more pooling layers that are alternately stacked or consecutively stacked. The output of the stacked convolution layers and pooling layers may be feature map of the input image that is equivariant to scale and translation with reduced feature dimensionality. The processor 202 subjects the output of the rectified feature map of a last pooling layer to a fully connected layer. The fully connected layer is a multilayer perceptron that uses a softmax function in an output layer of the 3D-CNN model. The fully connected layer uses the features in the rectified feature map of a last pooling layer for classifying the input image into various classes. The output of the fully connected layer is arbitrary real-valued scores based on the training video data sets of the 3D-CNN model. The softmax function in the output layer of the 3D-CNN model constitutes a softmax layer of the 3D-CNN model. The softmax layer takes the arbitrary real-valued scores as input and outputs a vector values between 0 and 1 that sum up to 1, such as probabilities.

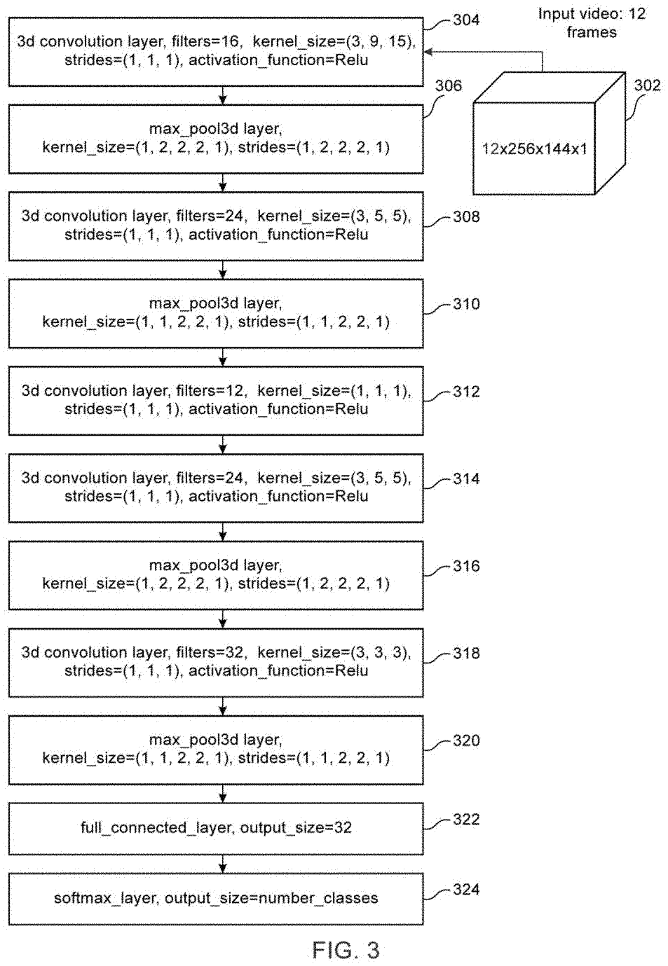

The processor 202 employs a 3D-CNN model 206 with an architecture similar to as disclosed above to determine a class of the input live video data. That is, the class defines the range of speed data of the vehicle 110. Based on the class, the processor 202 may determine the speed data of the vehicle 110 from the live video data. The specific architecture of the 3D-CNN model 206 used for determining the speed data of the vehicle 110 is disclosed in the detailed description of FIG. 3. For the 3D-CNN model 206 to determine the class indicating the speed of the vehicle 110, the processor 202 trains and validates the 3D-CNN model 206 as exemplarily illustrated in FIG. 4 on training video data sets and validation video data sets. The processor 202 may train and validate the 3D-CNN model 206 in substantially real-time.

The memory 204 may include processing instructions for training of the 3D-CNN model 206 with training video data sets that may be real-time video data or historical video data, from vehicles, such as 110. In an embodiment, the training video data may be divided into two sets, a training video data set for training the 3D-CNN model 206 and a validation video data set for validating the trained 3D-CNN model 206 to determine an accuracy of the trained 3D-CNN model 206. The processor 202 may generate the trained 3D-CNN model 206 that determines speed data of the vehicle 110 for an input live video data at substantially real-time. In one embodiment, the processor 202 uses a training video data set for training the 3D-CNN model 206 to determine speed data of the vehicle 110. For an input in the training video data set, the processor 202 trains the 3D-CNN model 206 to generate a corresponding class indicating speed data of the vehicle 110.

The training video data sets comprise a plurality of sets of video data captured by one or more vehicles whose speeds are known. The training video data sets are labeled video data sets on which the processor 202 trains the 3D-CNN model 110. Training video data sets comprise a collection of training video data. The training video data may comprise a video that is divided into a plurality of video clips of 12 image frames and a video clip of 12 image frames is labeled with a class indicating the speed of vehicle 110 while capturing the video. A video clip of 12 image frames labeled as class 0 indicates the speed of the vehicle 110 to be 0 km/hr, another video clip of 12 image frames labeled as class 1 indicates the speed of the vehicle 110 to be between 0 km/hr to 5 km/hr. Similarly class 2 indicates the speed of the vehicle 110 to be between 5 km/hr to 10 km/hr and class 3 indicates the speed of the vehicle 110 to be between 10 km/hr to 15 km/hr. Similarly, class 28 indicates the speed of the vehicle 1110 to be between 135 km/hr to 140 km/hr, class 29 indicates the speed of the vehicle 110 to be between 140 km/hr to 145 km/hr, and class 30 indicates the speed of the vehicle 110 to be between 145 km/hr to 150 km/hr. The processor 202 trains the 3D-CNN model 206 with the architecture as in FIG. 3 on about 150000 video clips of 12 image frames each to generate a class between 0-30 for each of the video clips.

Prior to training the 3D-CNN model 206, the architecture of the 3D-CNN model 206 is selected as exemplarily illustrated in FIG. 3. The 3D-CNN model 206 may comprise a first convolution layer followed by a first pooling layer, a second convolution layer, a second pooling layer, a third convolution layer, a fourth convolution layer, a third pooling layer, a fifth convolution layer, a fourth pooling layer, a fully connected layer, and a softmax layer. The number of filters and filter sizes may also be predetermined and do not change during the process of training.

For training the 3D-CNN model 206 with the above disclosed architecture using a plurality of training video data sets, the kernels of a filter in the convolution layers may be manually initialized with random values and weights of connections between neurons in the fully connected layer may also be manually initialized, via the user device. For a plurality of video clips of the training video data of 12 image frames, the 3D-CNN model 206 may output classes at the fully connected layer. The softmax layer of the 3D-CNN model 206 may output probability for each class. Since the weights and parameters in the kernels are randomly assigned, the output probabilities associated with the plurality of video clips may also be random. The processor 202 calculates a total error, that is a mean-squared error, at the softmax layer as total error=Σ½ (target probability—output probability)².

The processor 202 may use backpropagation to calculate gradients of the error with respect to the weights and the parameters and processor 202 may use gradient descent to update the parameters of the kernel and the weights to minimize the total error. The processor 202 may adjust weights and the parameters of the kernel based on their contribution to the total error. With the adjusted weights and parameters of the kernel, the 3D-CNN model 206 may again generate the output probabilities for the plurality of video clips and the output probabilities may be closer to the target probabilities due to the adjusted weights and parameters. Since the output probabilities are closer to the target probabilities, the total error may be reduced and the processor 202 generates a trained 3D-CNN model 206 that determines the speed data of the vehicle 110 from the training video data set, where the determined speed of the vehicle 110 is closer to the actual speed of the vehicle 110. The trained 3D-CNN model 206 has the weights and the parameters of the kernels optimized to correctly generate a class indicating the actual speed data of the vehicle 110.

Post training, in one embodiment, the processor 202 may validate the trained 3D-CNN model 206 by providing a validation data set as an input. The validation data set, for example, may include video data, whose corresponding classes indicating speed data of the vehicle 110 are not fed to the trained 3D-CNN model 206. The trained 3D-CNN model 206 may be configured to output corresponding classes indicating the speed data of the vehicle 110. The processor 202 may be aware of correct corresponding classes indicating the speed data of the vehicle 110 for the validation video data and the processor 202 may compare the output of the trained 3D-CNN model 206 to the validation video data set with the correct corresponding classes indicating the speed data of the vehicle 110. The processor 202 may evaluate the accuracy of the trained 3D-CNN model 206. In one embodiment, if the accuracy of the trained 3D-CNN model 206 is less than a threshold value, the processor 202 may re-train the trained 3D-CNN model 206 and a validated 3D-CNN model 206 with an improved accuracy is generated.

The processor 202 inputs the live video data captured by the sensors 108 of the user device 202 or the vehicle 110 to the validated 3D-CNN model 206 to determine the speed data of the vehicle 110. In an embodiment, the processor 202 may perform preprocessing of the live input video data prior to providing the live video data to the 3D-CNN model 206. As a part of preprocessing of the live input video data, the processor 202 may divide the live input video data into a plurality of video clips, where each video clip comprises an equal number of image frames of reduced resolution. The processor 202 inputs the plurality of video clips with same frame count to the validated 3D-CNN model 206. Based on the weights and the parameters of the kernels that are optimized to values as shown in FIG. 3, the 3D-CNN model 206 outputs a class indicating the speed of the vehicle 110. The processor 202, based on the output class, computes the speed data of the vehicle 110. From the output class, the processor 202 multiplies the class with a factor 5 to obtain the speed data of the vehicle 110.

The processor 202 may render the determined speed data of the vehicle 110 on the user interface 106 of the user device 102. The user interface 106 of the user device 102 may in turn be in communication with the system 122 to provide output to the user and, in some embodiments, to receive an indication of a user input, such as, the filter size, number of layers in the 3D-CNN model 206. In some example embodiments, the user interface 106 may communicate with the system 122 and displays input and/or output of the system 122. As such, the user interface 106 may include a display and, in some embodiments, may also include a keyboard, a mouse, a joystick, a touch screen, touch areas, soft keys, one or more microphones, a plurality of speakers, or other input/output mechanisms. In one embodiment, the system 122 may comprise user interface circuitry configured to control at least some functions of one or more user interface elements such as a display and, in some embodiments, a plurality of speakers, a ringer, one or more microphones and/or the like. The processor 202 and/or user interface circuitry comprising the processor 202 may be configured to control one or more functions of one or more user interface elements through computer program instructions (for example, software and/or firmware) stored on a memory 204 accessible to the processor 202.

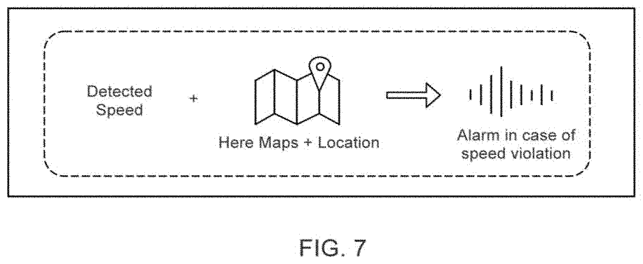

In an embodiment, the processor 202 may compare the determined speed of the vehicle 110 with the rated speed at the location of the vehicle 110 to generate a speed violation notification as disclosed in the detailed description of FIG. 7. The processor 202 may further render the speed violation notification on the user interface 106 of the user device 102. As the speed of the vehicle 110 changes along a route based on the conditions on the route, such as, roadwork zone, no-overtake zone, etc., the 3D-CNN model 206 may determine the variations in the speed of the vehicle 110 in substantially real-time and the processor 202 may update the rendered speed data on the user device 102.

FIG. 3 exemplarily illustrates a flowchart showing the architecture of the validated 3D-CNN model, in accordance with an exemplarily embodiment. As exemplarily illustrated, the validated 3D-CNN model 206 comprises a first convolution layer 304 followed by a first pooling layer 306, a second convolution layer 308, a second pooling layer 310, a third convolution layer 312, a fourth convolution layer 314, a third pooling layer 316, a fifth convolution layer 318, a fourth pooling layer 320, a fully connected layer 322, and a softmax layer 324. The input to the first convolution layer 304 is a video clip 302 of video data of 12 image frames, each image frame of size 256*144*1 pixels. The input video data of size 180*720*3 pixels is fed to the processor 202 and the processor 202 divides the live input video data into a plurality of video clips 302 of 12 image frames, each of the size 256*144*1 pixels. The processor 202 reduces the resolution of the live input video to make computation of the speed data by the 3D-CNN model 206 faster and simpler without losing the features in the live input video data.

The 12 frames of images are input the first convolution layer 304 of the validated 3D-CNN model 206 whose number of filters are configured to be 16 and kernel size is also preconfigured to be (3,9, 15) with strides as (1,1,1) and an activation function as Relu. The output of the first convolution layer 304 is a feature map that is passed to the first pooling layer employing maxpooling. The output of the first pooling layer 306 is a maxpooled feature map that is input to the second convolution layer 308 configured with 24 filter, kernel size (3,5, 5), strides=(1,1,1) and the activation function as Relu as exemplarily illustrated. Similarly, the output of the second convolution layer 308 is input to the second pooling layer 310. The second pooling layer 310 is connected to the third convolution layer 312, the third convolution layer 312 is connected to the fourth convolution layer 314, and the fourth convolution layer 314 is connected to the third pooling layer 316. The output of the third pooling layer 316 is input to the fifth convolution layer 318, the fifth convolution layer 318 is connected to the fourth pooling layer 320 to obtain a maxpooled feature map at the output of the fourth pooling layer 320. The max pooled feature is input to the fully connected layer 322 whose output size is 32. The fully connected layer 322 determines the class indicating the speed data of the vehicle 110 based on the classes, the validated 3D-CNN model 206 is trained. The number of classes that can be output of the fully connected layer may be 322. The classes output by the fully connected layer 322 is input to the softmax layer 324 that outputs a probability corresponding to the class. Based on the class of the output of the fully connected layer 322, the processor 202 may compute the speed data of the vehicle 110 by multiplying the class with a factor of 5.

The convolution layers, that is, the first convolution layer 304, the second convolution layer 308, the third convolution layer 312, the fourth convolution layer 314, and the fifth convolution layer 318 extract the spatio-temporal features in the video clip 302 of image frames that change from one image to another image. The processor 202 obtains difference in the 12 frames of the video clip 302 to analyze and determine the speed data of the vehicle 110.

A code snippet of the 3D-CNN model 206 executed by the processor 202 of the system 122 is as given below:

import tensorflow as tf
import numpy as np
FILTERS_1 = 16
FILTERS_2 = 24
FILTERS_3 = 12
FILTERS_4 = 24
FILTERS_5 = 32
FC_SIZE = 32
DTYPE = tf.float32
def inference(boxes, num_classes):

layer = tf.layers.conv3d(inputs=boxes, filters=FILTERS_1, kernel_size=(3, 9, 15),

strides=(1, 1, 1),

kernel_initializer=tf.contrib.layers.xavier_initializer(uniform=False, seed=1,

dtype=DTYPE),

activation=tf.nn.relu, padding=‘same’, name=‘layer_1’)

layer = tf.nn.max_pool3d(layer, ksize=[1, 2, 2, 2, 1], strides=[1, 2, 2, 2, 1], padding=‘SAME’,

name=‘layer_2’)

# layer.shape: (?,6,72,128,32)
layer = tf.layers.conv3d(inputs=layer, filters=FILTERS_2, kernel_size=(3, 5, 5), strides=(1, 1,

1),

kernel_initializer=tf.contrib.layers.xavier_initializer(uniform=False, seed=1,

dtype=DTYPE),

activation=tf.nn.relu, padding=‘same’, name=‘layer_3’)

layer = tf.nn.max_pool3d(layer, ksize=[1, 1, 2, 2, 1], strides=[l, 1, 2, 2, 1], padding=‘SAME’,

name=‘layer_4’)

# layer.shape: (?,6,36,64,48)
layer = tf.layers.conv3d(inputs=layer, filters=FILTERS_3, kernel_size=(1, 1, 1), strides=(1, 1,

1),

kernel_initializer=tf.contrib.layers.xavier_initializer(uniform=False, seed=1,

dtype=DTYPE),

activation=tf.nn.relu, padding=‘same’, name=‘layer_5’)

layer = tf.layers.conv3d(inputs=layer, filters=FILTERS_4, kernel_size=(3, 5, 5), strides=(1, 1,

1),

kernel_initializer=tf.contrib.layers.xavier_initializer(uniform=False, seed=1,

dtype=DTYPE),

activation=tf.nn.relu, padding=‘same’, name=‘layer_6’)

layer = tf.nn.max_pool3d(layer, ksize=[1, 2, 2, 2, 1], strides=[1, 2, 2, 2, 1], padding=‘SAME’,

name=‘layer_7’)

# layer.shape: (?,3,18,32,48)
layer = tf.layers.conv3d(inputs=layer, filters=FILTERS_5, kernel_size=(3, 3, 3), strides=(1, 1,

1),

kernel_initializer=tf.contrib.layers.xavier_initializer(uniform=False, seed=1,

dtype=DTYPE),

activation=tf.nn.relu, padding=‘same’, name=‘layer_8’)

layer = tf.nn.max_pool3d(layer, ksize=[1, 1, 2, 2, 1], strides=[1, 1, 2, 2, 1], padding=‘SAME’,

name=‘layer_9’)

# layer.shape: (?,3,9,16,64)
layer_flat = tf.contrib.layers.flatten(layer, scope=‘layer_flat’)
# layer_flat.shape: (?,27648)
layer = tf.layers.dense(layer_flat, FC_SIZE, name=‘layer_10’)
layer = tf.layers.dense(layer, num_classes, name=‘layer_11’)
return layer

FIG. 4 exemplarily illustrates a flowchart comprising the steps performed by the system 122 for training and validating the 3D-CNN model for determining the speed data of the vehicle 110 from live video data, in accordance with an embodiment. The system 122 receives training video data and splits the training video data into multiple training video data sets 402. The training video data sets comprise the historic video data 402A with corresponding speed data of the vehicle 110 from which the historic video data are captured. The system 122 splits the historic video data into short clips of a fixed number of frames (X) with corresponding labeled speed 402B. The system 112 also receives validation video data sets 406 from a source database. The system 122 uses the training data sets 402 as input for training 404 the 3D-CNN model 206. On training 404 the 3D-CNN model 206, the system 122 generates the trained 3D-CNN model as disclosed in detailed description of FIG. 2. The system 122 validates 408 the generated trained 3D-CNN model against the validation video data sets 406 using short clips of X frames that are speed labeled in the validation video data sets 406.

The system 122 determines 410 whether the trained 3D-CNN model has an acceptable accuracy. The accuracy of the trained 3D-CNN model refers to the number of times the trained 3D-CNN model makes a correct prediction of the speed data of the vehicle 110 labeled in the validation video data sets 406 when compared with the expected output for the speed of the vehicle 110 labeled in the validation data sets 406. In an embodiment, a user of the system 122 configures the acceptable accuracy for the trained 3D-CNN model. If the trained 3D-CNN model exhibits the acceptable accuracy against the validation video data sets 406, the system 122 generates a validated 3D CNN model 414 from the trained 3D-CNN model. If the trained 3D-CNN model does not exhibit the acceptable accuracy against the validation video data set 406, the system 122 re-trains 404 the trained 3D-CNN model until the acceptable accuracy 410 is met. That is, the system 122 generates the validated 3D-CNN model 414 when the generated trained 3D-CNN model corresponding to the training video data sets 402 meets a predetermined criterion, that is, the acceptable accuracy, on testing the generated trained 3D-CNN model 404 against the validation video data set 406. The system 122 retrains the generated trained 3D-CNN model 404 on the training video data sets 402 until the generated trained 3D-CNN model 404 meets the predetermined criterion, that is, the acceptable accuracy, for the generation of the validated 3D-CNN model 414. The system 122 inputs the live video data 412, that is, the real time video recording that is converted into short clips of fixed frame count to the validated 3D-CNN model 414. The validated 3D-CNN model 414 outputs the speed data of the vehicle 110 from the live video data 412.

FIGS. 5A-5L exemplarily illustrate a video clip 302 of image frames constituting the training video data sets for training the 3D-CNN model 206, in accordance with an embodiment. As exemplarily illustrated, the image frames form a sequence of images captured by the sensors 108 of the vehicle 110 whose speed is known. The image frames have a corresponding labeled speed as 38 km/hr. The 3D-CNN model 206 is trained on the spatio-temporal features of the frames, such as, displacement of the elements, such as trees, building, etc., in the series of frames, with time. The weights and the parameters of the kernel are altered during the process of training for the 3D-CNN model 206 to determine the speed of the vehicle 110 to be closer to the labeled speed of 38 km/hr.

FIGS. 6A-6L exemplarily illustrate a video clip 302 of image frames constituting the training video data sets for training the 3D-CNN model 206, in accordance with an embodiment. As exemplarily illustrated, frames form a sequence of images captured by the sensors of the vehicle whose speed is known. The image frames have a corresponding labeled speed as 128 km/hr. The 3D-CNN model 206 is trained on the spatio-temporal features of the image frames, such as, displacement of the elements, such as lampposts, trees, etc., in the series of frames, with time. The weights and the parameters of the kernel are altered during the process of training for the 3D-CNN model 206 to determine the speed of the vehicle 110 to be closer to the labeled speed of 128 km/hr. The processor 202 obtains a trained 3D-CNN model 206 with the parameters configured to determine different speeds of the vehicle 110, irrespective of the elements in the images. The processor 202 validates the trained 3D-CNN model 206 and obtains the validated 3D-CNN model 206 of the architecture as shown in FIG. 3. The validated 3D-CNN model 206 is input with the live input video data as disclosed in the detailed description of FIG. 3.

FIG. 7 exemplarily illustrates a schematic diagram representing generation of a speed violation notification by the system 122, in accordance with an embodiment. As exemplarily illustrated, based on the determined speed data of the vehicle, the system 122 generates the speed violation notification and renders the speed violation notification on an output interface, that is, the user interface 106 of the user device 102. The system 122 accesses the mapping platform and the map database as disclosed in the detailed description of FIG. 1 through the network 120. The sensors 108 of the vehicle 110 may generate location data of the vehicle 110. The system 122 maps the location data of the vehicle 110 to the links in the map database 112 and the system 122 may extract rated speed on those links. The system 122 determines if the determined speed of the vehicle 110 is above the rated speed on those links and generates the speed violation notification as a text notification or an audio notification on the user interface 106 of the user device 102.

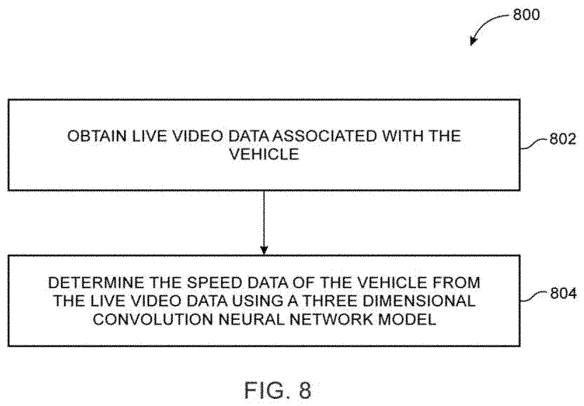

FIG. 8 exemplarily illustrates a method 800 for determining speed data of the vehicle 110, in accordance with an example embodiment. It will be understood that each block of the flow diagram 800 of the method may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 122, employing an embodiment of the present invention and executed by a processor 202 of the system 122. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory 204 that may direct a computer or other programmable apparatus to function in a particular manner, such that the instructions stored in the computer-readable memory 204 produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 800 support combinations of means for performing the specified functions and combinations of operations for performing the specified functions for performing the specified functions. It will also be understood that one or more blocks of the flow diagram 800, and combinations of blocks in the flow diagram 800, can be implemented by special purpose hardware-based computer systems which perform the specified functions, or combinations of special purpose hardware and computer instructions. A method illustrated by the flow diagram 800 of FIG. 8 for determining speed data of a vehicle 110 includes, at 802, obtaining live video data associated with the vehicle 110. The live video data comprises one or more video clips, each having equal frame count. At 804, the method 800 may include determining the speed data of the vehicle 110 from the live video data using a three dimensional (3D) convolution neural network (CNN) model 206. The 3D-CNN model 206 comprises a plurality of convolution layers, a plurality of pooling layers, and a plurality of fully connected layers.

In an example embodiment, a system for performing the method of FIG. 8 above may comprise a processor (e.g. the processor 202) configured to perform some or each of the operations (802-804) described above. The processor may, for example, be configured to perform the operations (802-804) by performing hardware implemented logical functions, executing stored instructions, or executing algorithms for performing each of the operations. Alternatively, the system may comprise means for performing each of the operations described above. In this regard, according to an example embodiment, examples of means for performing operations 802-804 may comprise, for example, the processor 202 and/or a device or circuit for executing instructions or executing an algorithm for processing information as described above.

On implementing the method 800 disclosed herein, the end result generated by the system 122 is a tangible determination of speed data of a vehicle from live video data. The determination of the speed data of the vehicle is of utmost importance to avoid mishaps from happening in roadwork zones, busy streets, highways, freeways, etc. In case of testing and deployment of autonomous vehicles, the remote determination of the speed of the vehicle may be used to study the behavior of the autonomous vehicles and effects of collisions on the structure of the autonomous vehicle. The determination of the speed of the vehicle in real-time avoids the necessity to deploy GPS module or any geo-positioning or speed sensors in determining the speed of the vehicle. The determination of the speed data of the vehicle using the 3D-CNN model may be used as a secondary means of determining the speed to calibrate the speed sensor of the vehicle.

The method disclosed herein provides an improvement in computer related technology related to speed determination as follows: The system 122 determines speed of the vehicle based on the training video data sets and the validation video data sets. The 3D-CNN model is trained on all different terrains, streets, speeds, etc., for accurately determining the speed of the vehicle in real-time. The speed determination using the 3D-CNN model is a cheaper solution since it does not involve any specific hardware, except for a user device with an imaging sensor. Further, signal strength related issues in positioning sensors (such as GPS) are also mitigated as the claimed solution utilizes video data as input for determining the speed. The 3D-CNN model is compact, fast and can be executed on a user device. The 3D-CNN model is compact since it works on 3×10̂5 spatio-temporal parameters whereas the existing CNN models operate on 10̂9 spatio-temporal parameters. The system 122 may also store the generated speed data in the memory and the stored speed data may be used to analyze accident situations and nab the culprits.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for determining speed data of a vehicle, the system comprising:
at least one memory configured to store computer program code instructions; and
at least one processor configured to execute the computer program code instructions to:
obtain live video data associated with the vehicle, wherein the live video data comprises one or more video clips, each having equal frame count; and
determine the speed data of the vehicle from the live video data using a three dimensional (3D) convolution neural network (CNN) model, wherein the 3D-CNN model comprises a plurality of convolution layers, a plurality of pooling layers, and a plurality of fully connected layers.

2. The system of claim 1, wherein the at least one processor is further configured to generate a speed violation notification based on the determined speed data of the vehicle.

3. The system of claim 2, wherein the at least one processor is further configured to control an output interface of one or more user devices associated with the vehicle to render the generated speed violation notification.

4. The system of claim 1, wherein the at least one processor is further configured to preprocess the live video data associated with the vehicle into the one or more video clips comprising a plurality of image frames.

5. The system of claim 1, wherein the 3D-CNN model comprises a first set of layers including two convolution layers of the plurality of convolution layers and two pooling layers of the plurality of pooling layers stacked in an alternating sequence.

6. The system of claim 5, wherein the 3D-CNN model further comprises a second set of layers connected to the first set of layers including a third convolution layer and a fourth convolution layer of the plurality of convolution layers connected to the first set of layers in succession, a third pooling layer connected to the fourth convolution layer, a fifth convolution layer connected to the third pooling layer, a fourth pooling layer connected to the fifth convolution layer in a sequence.

7. The system of claim 6, wherein the 3D-CNN model further comprises a fully connected layer connected to the second set of layers and a softmax layer connected to the fully connected layer.

8. The system of claim 1, wherein the at least one processor is further configured to extract spatio-temporal features of the live-video data using the plurality of convolution layers and the plurality of pooling layers of the 3D-CNN model.

9. A method for determining speed data of a vehicle, the method comprising:
obtaining live video data associated with the vehicle, wherein the live video data comprises one or more video clips, each having equal frame count; and
determining the speed data of the vehicle from the live video data using a three dimensional (3D) convolution neural network (CNN) model, wherein the 3D-CNN model comprises a plurality of convolution layers, a plurality of pooling layers, and a plurality of fully connected layers.

10. The method of claim 9, further comprising generating a speed violation notification based on the determined speed data of the vehicle.

11. The method of claim 10, further comprising controlling an output interface of one or more user devices associated with the vehicle to render the generated speed violation notification.

12. The method of claim 9, further comprising preprocessing the live video data associated with the vehicle into one or more video clips comprising a plurality of image frames.

13. The method of claim 9, wherein the 3D-CNN model comprises a first set of layers including two convolution layers of the plurality of convolution layers and two pooling layers of the plurality of pooling layers stacked in an alternating sequence.

14. The method of claim 13, wherein the 3D-CNN model further comprises a second set of layers connected to the first set of layers including a third convolution layer, and a fourth convolution layer of the plurality of convolution layers connected to the first set of layers in succession, a third pooling layer connected to the fourth convolution layer, a fifth convolution layer connected to the third pooling layer, a fourth pooling layer connected to the fifth convolution layer in a sequence.

15. The method of claim 14, wherein the 3D-CNN model further comprises a fully connected layer connected to the second set of layers and a softmax layer connected to the fully connected layer.

16. The method of claim 9, further comprising extracting spatio-temporal features of the live-video data using the plurality of convolution layers and the plurality of pooling layers.

17. A computer program product comprising at least one non-transitory computer-readable storage medium having stored thereon computer-executable program code instructions which when executed by a computer, cause the computer to carry out operations for determining speed data of a vehicle, the operations comprising:
obtaining live video data associated with the vehicle, wherein the live video data comprises one or more video clips, each having equal frame count; and
determining the speed data of the vehicle from the live video data using a three dimensional (3D) convolution neural network (CNN) model, wherein the 3D-CNN model comprises a plurality of convolution layers, a plurality of pooling layers, and a plurality of fully connected layers.

18. The computer program product of claim 17, where the operations further comprise:
generating a speed violation notification based on the determined speed data of the vehicle; and
controlling an output interface of one or more user devices associated with the vehicle to render the generated speed violation notification.

19. The computer program product of claim 17, wherein the operations further comprise preprocessing the live video data associated with the vehicle into one or more video clips comprising a plurality of image frames.

20. The computer program product of claim 17, wherein the operations further comprise extracting spatio-temporal features of the live-video data using the plurality of convolution layers and the plurality of pooling layers.
